(19) United States
(12) Patent Application Publication
(10) Pub. No.: US 2026/0156676 A1
(43) Pub. Date: Jun. 4, 2026

(54) GNSS AND SATELLITE COMMUNICATION COEXISTENCE

(71) Applicant: Apple Inc., Cupertino, CA (US)

(72) Inventors: Aditya N Srivastava, Fremont, CA (US); Mark T Dawkins, San Jose, CA (US); Richard J Najarian, Palos Verdes Estates, CA (US); Idan Bar-Sade, Sunnyvale, CA (US); Sheu Sheu Tan, Mountain View, CA (US)

(21) Appl. No.: 18/965,831

(22) Filed: Dec. 2, 2024

(51) Int. Cl. H04W 74/0816; H04W 24/08; H04W 84/06

(52) U.S. Cl. CPC H04W 74/0816; H04W 24/08; H04W 84/06

(57) ABSTRACT

An electronic device may communicate with a non-terrestrial network (NTN) using an external clock of the NTN. The electronic device may determine the external clock to communicate with the NTN. The device may receive an indication of the external clock from a global navigational satellite system (GNSS) or from interfering signals. The interfering signals may at least partially mask GNSS signals. A nearby device may be transmitting the interfering signals to the NTN using the external clock. The nearby device may embed a predetermined pattern of quiet periods or transmission gaps with each frame cycle of the external clock. The electronic device may determine a relationship (e.g., time duration offset) between the quiet periods of the predetermined pattern of quiet periods and frame boundaries of the frame cycles of the external clock. As such, the electronic device may communicate signals with the NTN despite the GNSS signals being masked.

### BACKGROUND

The present disclosure relates generally to satellite communication via a mobile communication device, and more specifically to coexistence between a non-terrestrial network (NTN) and a global navigational satellite system (GNSS) network.

Due to GNSS in-band interference, devices (e.g., user equipment, mobile communication devices, smartphones, and so on) may not receive GNSS signals and/or may be prevented from communicating with or using NTNs, peer-to-peer (P2P) networks, or other standalone networks. This may be because, for communication on NTNs, P2P networks, or other standalone networks without a centralized time reference, a GNSS position, time estimate, and/or velocity estimate may be used to establish a connection. However, the GNSS in-band interference may prevent a device from receiving the GNSS position, time estimate, and/or velocity estimate.

This section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

In one embodiment, an electronic device is described. The electronic device may include a transceiver that may include a receiver and a transmitter and processing circuitry that may be to the transceiver. The processing circuitry may instruct the receiver to receive a first signal from a first network, the first signal including an indication of an external clock associated with a second network, receive interference during interference time periods in lieu of or in addition to the first signal via the receiver, and transmit a second signal to the second network by the transceiver based on a pattern of one or more received quiet time periods between the interference time periods, and a stored pattern of one or more quiet time periods corresponding to the pattern of the one or more received quiet time periods, where the stored pattern is indicative of the external clock.

In another embodiment, a method is described including operation performed by processing circuitry. The method includes instructing a receiver to receive a first signal of a first frequency band, where the first signal comprises an indication of an external clock for communicating a second signal of a second frequency band, receiving interference during interference time periods that at least partially mask the first signal via the receiver, and transmitting the second signal by a transmitter based on one or more quiet time periods being received between the interference time periods and the external clock being associated with the one or more quiet time periods.

In yet another embodiment, tangible, non-transitory, computer-readable media storing instructions is described that, when executed by processing circuitry, may cause the processing circuitry to instruct a receiver to receive a first signal of a first frequency band, the first signal including an indication of an external clock to communicate a second signal of a second frequency band, determine whether the receiver is receiving interference during interference time periods in lieu or in addition to the first signal, determine a pattern of quiet time periods being received based on the interference time periods, determine the external clock based on the pattern of quiet time periods, and transmit the second signal by a transmitter based on the external clock.

Various refinements of the features noted above may exist in relation to various aspects of the present disclosure. Further features may also be incorporated in these various aspects as well. These refinements and additional features may exist individually or in any combination. For instance, various features discussed below in relation to one or more of the illustrated embodiments may be incorporated into any of the above-described aspects of the present disclosure alone or in any combination. The brief summary presented above is intended only to familiarize the reader with certain aspects and contexts of embodiments of the present disclosure without limitation to the claimed subject matter.

### BRIEF DESCRIPTION OF THE DRAWINGS

Various aspects of this disclosure may be better understood upon reading the following detailed description and upon reference to the drawings described below in which like numerals refer to like parts.

FIG. 1 is a block diagram of user equipment, according to embodiments of the present disclosure;

FIG. 2 is a functional diagram of the user equipment of FIG. 1, according to embodiments of the present disclosure;

FIG. 3A is a schematic diagram of a communication system that includes a global navigational satellite system (GNSS), a non-terrestrial network (NTN), and a first device (in the form of the user equipment of FIG. 1) establishing communication and communicating with the NTN based on receiving a time reference for communicating with the NTN from the GNSS, according to embodiments of the present disclosure;

FIG. 3B is a schematic diagram of the communication system of FIG. 3A where a second device (in the form of the user equipment of FIG. 1) establishes communication and communicates with the NTN based on receiving the time reference with in-band interference associated with communication of the first device with the NTN, according to embodiments of the present disclosure;

FIG. 4A is a timing diagram illustrating a first pattern of a quiet period embedded with a frame cycle of the signals for communication with the NTN received or transmitted by the first device and/or the second device of FIGS. 3A and 3B, according to embodiments of the present disclosure;

FIG. 4B is a timing diagram illustrating a second pattern of multiple quiet periods embedded with a frame cycle of the signals for communication with the NTN received or transmitted by the first device and/or the second device of FIGS. 3A and 3B, according to embodiments of the present disclosure; and

FIG. 5 is a process flow diagram illustrating an embodiment of a process of establishing connection and communicating with the NTN by the user equipment of FIGS. 1-3 based on whether the in-band interferences are present, in accordance with an aspect of the present disclosure.

### DETAILED DESCRIPTION OF SPECIFIC EMBODIMENTS

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers'specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. Furthermore, the particular features, structures, or characteristics may be combined in any suitable manner in one or more embodiments. Use of the terms “approximately,” “near,” “about,” “close to,” and/or “substantially” should be understood to mean including close to a target (e.g., design, value, amount), such as within a margin of any suitable or contemplatable error (e.g., within 0.1 % of a target, within 1% of a target, within 5% of a target, within 10% of a target, within 25% of a target, and so on). Moreover, it should be understood that any exact values, numbers, measurements, and so on, provided herein, are contemplated to include approximations (e.g., within a margin of suitable or contemplatable error) of the exact values, numbers, measurements, and so on. Additionally, the term “set” may include one or more. That is, a set may include a unitary set of one member, but the set may also include a set of multiple members. Furthermore, the term “continuous” may correspond to an activity that occurs without interruption or a consecutive repetition with a relatively short time period therebetween.

This disclosure is generally directed to enabling coexistence between a non-terrestrial network (NTN) and a global navigational satellite system (GNSS) network. A device (e.g., user equipment, electronic device) may communicate with an NTN using frame cycles or an external clock associated with communicating with the NTN. The device may determine the frame cycles or periodic transmission windows, hereinafter NTN frame cycles, before communicating with the NTN. The GNSS may transmit (e.g., broadcast) GNSS signals indicative of the NTN frame cycles. The device may receive the indication of the NTN frame cycles from the GNSS to communicate with the NTN. However, in some cases, interfering signals (e.g., GNSS in-band interference) may prevent a device from receiving the GNSS signals. In such cases, the device may determine the NTN frame cycles from the interfering signals (e.g., GNSS in-band interference) of a nearby device masking the GNSS signals when the nearby device is communicating with the NTN, as discussed herein.

For example, another device (e.g., a transmitting device) may transmit NTN signals directed to the NTN. The NTN signals of the transmitting device may destructively interfere with (e.g., partially mask) GNSS signals in an area including a receiving device. The receiving device may use timing of the interfering NTN signals of the transmitting device to establish communication with the NTN. In some cases, the transmitting device may transmit the NTN signals using the NTN frame cycles by embedding a predetermined (e.g., standardized) pattern of quiet periods (e.g., quiet time periods) or transmission gaps with each NTN frame cycle. The receiving device may determine the pattern of quiet periods by monitoring (e.g., listening to) the interfering NTN signals masking (e.g., partially masking) the GNSS signals.

Moreover, the receiving device may store and retrieve one or more time duration offsets of the predetermined pattern of quiet periods to determine the NTN frame cycles. The time duration offsets may be indicative of boundaries of the frame cycles with respect to the predetermined pattern of quiet periods. For example, the time duration offsets may be indicative of or correspond to a transmission time offset or a beginning of a subsequent NTN frame cycle. As such, the receiving device may determine the NTN frame cycles when the NTN signals of the transmitting device destructively interfere and/or mask the GNSS signals. Furthermore, the receiving device may proceed to communicate signals with the NTN despite the GNSS signals being masked or partially masked at a subsequent NTN frame cycle. Accordingly, operations of the receiving device may be improved based on leveraging interfering signals of a transmitting device to establish communication and communicate with the NTN.

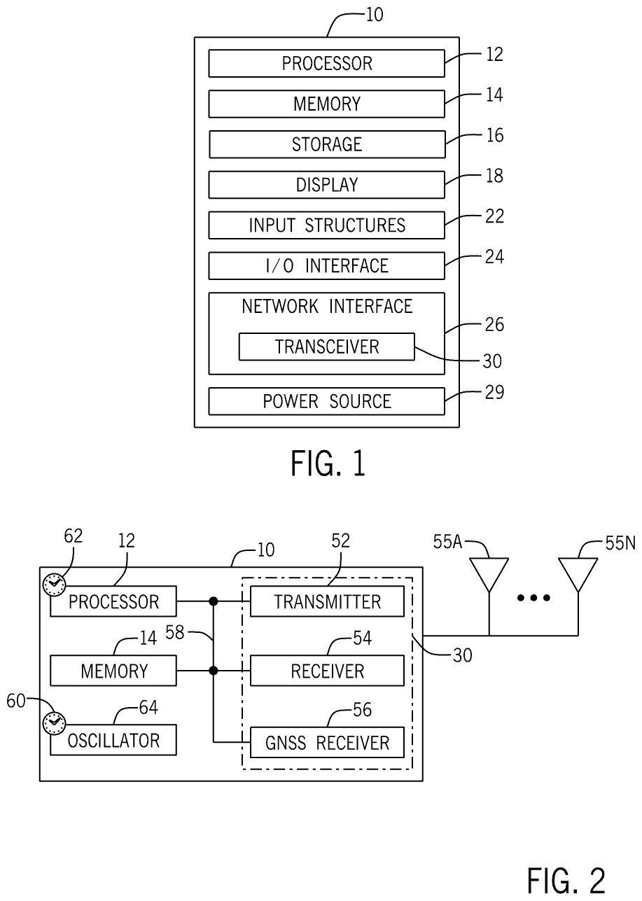

With the foregoing in mind, FIG. 1 is a block diagram of an electronic device 10 (e.g., a user equipment or a mobile communication device), according to embodiments of the present disclosure. The electronic device 10 may include, among other things, one or more processors 12 (collectively referred to herein as a single processor for convenience, which may be implemented in any suitable form of processing circuitry), memory 14, nonvolatile storage 16, a display 18, input structures 22, an input/output (I/O) interface 24, a network interface 26, and a power source 29. The various functional blocks shown in FIG. 1 may include hardware elements (including circuitry), software elements (including machine-executable instructions) or a combination of both hardware and software elements (which may be referred to as logic). The processor 12, the memory 14, the nonvolatile storage 16, the display 18, the input structures 22, the input/output (I/O) interface 24, the network interface 26, and/or the power source 29 may each be communicatively coupled directly or indirectly (e.g., through or via another component, a communication bus, a network) to one another to transmit and/or receive signals between one another. It should be noted that FIG. 1 is merely one example of a particular implementation and is intended to illustrate the types of components that may be present in the electronic device 10.

By way of example, the electronic device 10 may include any suitable computing device, including a desktop or notebook computer, a portable electronic or handheld electronic device, such as a wireless electronic device or smartphone, a tablet, a wearable electronic device, and other similar devices. It should be noted that the processor 12 and other related items in FIG. 1 may be generally referred to herein as “data processing circuitry.” Such data processing circuitry may be embodied wholly or in part as software, hardware, or both. Furthermore, the processor 12 and other related items in FIG. 1 may be a single contained processing module or may be incorporated wholly or partially within any of the other elements within the electronic device 10. The processor 12 may be implemented with any combination of general-purpose microprocessors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that may perform calculations or other manipulations of information. The processors 12 may include one or more application processors, one or more baseband processors, or both, and perform the various functions described herein.

In the electronic device 10 of FIG. 1, the processor 12 may be operably coupled with a memory 14 and a nonvolatile storage 16 to perform various algorithms. Such programs or instructions executed by the processor 12 may be stored in any suitable article of manufacture that includes one or more tangible, computer-readable media. The tangible, computer-readable media may include the memory 14 and/or the nonvolatile storage 16, individually or collectively, to store the instructions or routines. The memory 14 and the nonvolatile storage 16 may include any suitable articles of manufacture for storing data and executable instructions, such as random-access memory, read-only memory, rewritable flash memory, hard drives, and optical discs. In addition, programs (e.g., an operating system) encoded on such a computer program product may also include instructions that may be executed by the processor 12 to enable the electronic device 10 to provide various functionalities.

In certain embodiments, the display 18 may facilitate users to view images generated on the electronic device 10. In some embodiments, the display 18 may include a touch screen, which may facilitate user interaction with a user interface of the electronic device 10. Furthermore, it should be appreciated that, in some embodiments, the display 18 may include one or more liquid crystal displays (LCDs), light-emitting diode (LED) displays, organic light-emitting diode (OLED) displays, active-matrix organic light-emitting diode (AMOLED) displays, or some combination of these and/or other display technologies.

The input structures 22 of the electronic device 10 may enable a user to interact with the electronic device 10 (e.g., pressing a button to increase or decrease a volume level). The I/O interface 24 may enable the electronic device 10 to interface with various other electronic devices, as may the network interface 26. In some embodiments, the I/O interface 24 may include an I/O port for a hardwired connection for charging and/or content manipulation using a standard connector and protocol, such as a universal serial bus (USB) or other similar connector and protocol.

The network interface 26 may include, for example, one or more interfaces for a peer-to-peer connection, a personal area network (PAN), such as an ultra-wideband (UWB) or a BLUETOOTH network, for a local area network (LAN) or wireless local area network (WLAN), such as a network employing one of the IEEE 802.11x family of protocols (e.g., WI-FI), and/or for a wide area network (WAN), such as any standards related to the Third Generation Partnership Project (3GPP), including, for example, a 3^{rd} generation (3G) cellular network, universal mobile telecommunication system (UMTS), 4^{th} generation (4G) cellular network, long term evolution (LTE) cellular network, long term evolution license assisted access (LTE-LAA) cellular network, 5^{th} generation (5G) cellular network, New Radio (NR) cellular network, 6^{th} generation (6G) cellular network and beyond, a satellite connection (e.g., via an NTN), and so on.

In particular, the network interface 26 may include, for example, one or more interfaces for using a Release-15 cellular communication standard of the 5G specifications that include the millimeter wave (MM Wave) frequency range (e.g., 24.25-300 gigahertz (GHz)). The network interface 26 of the electronic device 10 may allow communication over the aforementioned networks (e.g., 5G, Wi-Fi, LTE-LAA, and so forth). The network interface 26 may also include one or more interfaces for, for example, broadband fixed wireless access networks (e.g., WIMAX), mobile broadband Wireless networks (mobile WIMAX), asynchronous digital subscriber lines (e.g., ADSL, VDSL), digital video broadcasting-terrestrial (DVB-T) network and its extension DVB Handheld (DVB-H) network, UWB network, alternating current (AC) power lines, and so forth.

The network interface 26 may, for instance, include a transceiver 30 for communicating signals using one of the aforementioned networks. The network interface 26 may include a transmitter, a receiver, and/or a GNSS receiver. In some embodiment, the electronic device 10 may generate and/or transmit signals (e.g., NTN signals) to communicate with an NTN by the transmitter. The electronic device 10 may generate and/or transmit the NTN signals with one or more cyclic patterns of quiet periods (e.g., transmission gaps) embedded with each frame cycle (e.g., NTN frame cycle, periodic transmission windows) of the NTN signals.

In some embodiments, the electronic device 10 may generate and/or transmit the NTN signals with voltage values equal to or higher than a high threshold and may include one or more quiet periods with voltage values equal to or below a low threshold within each frame cycle of the NTN signals. As such, each quiet period or cyclic pattern of quiet periods may separate two successive periods (e.g., portions) of a respective frame cycle of the NTN signals. For example, the electronic device 10 may generate and/or transmit a first portion of each frame cycle of the NTN signals separated by a quiet period or a cyclic pattern of quiet periods from a second portion of the frame cycle of the NTN signals.

The electronic device 10 may detect or receive GNSS signals and/or GNSS in-band interferences at the receiver and/or the GNSS receiver. In some cases, the GNSS in-band interferences may correspond to NTN signals transmitted by a nearby user equipment. For example, the nearby user equipment may generate and/or transmit the NTN signals using similar NTN frame cycles and/or cyclic patterns of quiet periods as the electronic device 10. Moreover, the electronic device 10 may receive, via the transceiver 30, a cyclic pattern of quiet periods (e.g., the transmission gaps) embedded between the GNSS in-band interferences transmitted by the nearby user equipment. Each quiet period or cyclic pattern of quiet periods may separate two successive periods (e.g., portions) of the GNSS in-band interferences. In particular, each quiet period or cyclic pattern of quiet periods may separate two successive periods (e.g., portions) of a respective frame cycle of the NTN signals. As such, the electronic device 10 may determine a boundary of the NTN frame cycles for communicating with the NTN based on monitoring (e.g., listening to) a timing of the cyclic pattern of quiet periods being received between the GNSS in-band interferences.

In some embodiments, the memory 14 and/or the nonvolatile storage 16 may store one or more predetermined patterns of quiet periods associated with each NTN frame cycle. Each predetermined pattern may indicate one or more predetermined time duration offsets between the cyclic quiet periods and a beginning and/or an end boundary (e.g., frame boundaries) of the NTN frame cycles. For example, the memory 14 and/or the nonvolatile storage 16 may store a table (e.g., a lookup table) storing the predetermined patterns and the respective time duration offsets. The electronic device 10 may determine whether the pattern of received quiet periods corresponds to a stored predetermined pattern of quiet periods. If so, the electronic device 10 may determine the frame boundaries of the NTN frame cycles based on a predetermined time duration offset of the predetermined pattern and may communicate with the NTN using the determined frame boundaries.

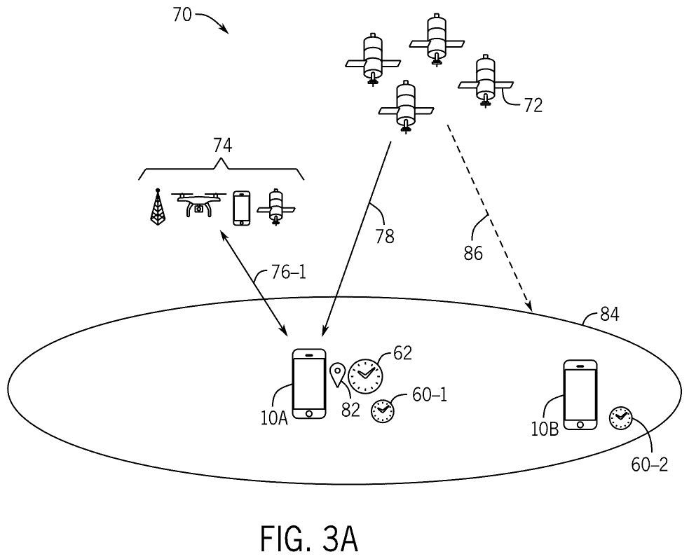

FIG. 2 is a functional diagram of the electronic device 10 of FIG. 1, according to embodiments of the present disclosure. As illustrated, the processor 12, the memory 14, the transceiver 30, a transmitter 52, a receiver 54, and/or antennas 55 (illustrated as 55A-55N, collectively referred to as an antenna 55), and/or a GNSS receiver 56 may be communicatively coupled directly or indirectly (e.g., through or via another component, a communication bus, a network) to one another to transmit and/or receive signals between one another. In some embodiments, the receiver 54 may include the GNSS receiver 56.

The electronic device 10 may include the transmitter 52 and/or the receiver 54 that respectively transmit and receive signals between the electronic device 10 and an external device via, for example, a network (e.g., including base stations) or a direct connection. As illustrated, the transmitter 52 and the receiver 54 may form the transceiver 30. The transmitter 52 may generate and/or transmit signals (e.g., NTN signals) to communicate with other user equipment, satellites, wireless networks, or any other viable receiver device. For example, the transmitter 52 (or the processor 12) may generate and/or transmit the NTN signals with one or more cyclic patterns of quiet periods (e.g., transmission gaps) embedded with each NTN frame cycle of the NTN signals. The patterns of quiet periods may be indicative of a time reference 62 (e.g., an external clock) indicative of timing information for communicating with the NTN, as will be appreciated.

The electronic device 10 may also have one or more antennas 55A-55N electrically coupled to the transceiver 30. The antennas 55A-55N may be configured in an omnidirectional or directional configuration, in a single-beam, dual-beam, or multi-beam arrangement. Each antenna 55 may be associated with one or more beams and various configurations. In some embodiments, multiple antennas of the antennas 55A-55N of an antenna group or module may be communicatively coupled to a respective transceiver 30 and each emit radio frequency signals that may constructively and/or destructively combine to form a beam. The electronic device 10 may include multiple transmitters, multiple receivers, multiple transceivers, and/or multiple antennas as suitable for various communication standards. For example, the electronic device 10 may include a first transceiver to send and receive messages using a first wireless communication network, a second transceiver to send and receive messages using a second wireless communication network, and so on, though any or all of these transceivers may be combined in a single transceiver.

The GNSS receiver 56 (or the receiver 54) may receive GNSS signals from a GNSS that includes one or more GNSS satellites and/or GNSS ground stations. For example, the GNSS signals may be received from a Global Positioning System (GPS) network, a Global Navigation Satellite System (GLONASS) network, a BeiDou Navigation Satellite System (BDS), a Galileo navigation satellite network, a Quasi-Zenith Satellite System (QZSS or Michibiki) and so on. The GNSS signals may also include a GNSS satellite's observation data, broadcast orbit information of tracked GNSS satellites, and supporting data, such as meteorological parameters, collected from co-located instruments of a GNSS satellite.

In the depicted embodiment, the various components of the electronic device 10 may be coupled together by a bus system 58. The bus system 58 may include a data bus, for example, as well as a power bus, a control signal bus, and a status signal bus, in addition to the data bus. Alternatively or additionally, the components of the electronic device 10 may be coupled together or accept or provide inputs to each other using some other mechanism.

The GNSS signals may include the time reference 62 indicative of timing information for communicating with the NTN. For example, the time reference 62 may include satellite clock correction information, GNSS or GPS date, satellite status, and so on. The time reference 62 may be indicative of frame boundaries of NTN signal's frame cycles for communicating with the NTN. In some embodiments, the processor 12 and/or the GNSS receiver 56 may receive and process the GNSS signals to determine the time reference 62 and/or a global position of the electronic device 10. As such, the processor 12 may determine the frame boundaries of the NTN frame cycles for communication with the NTN based on receiving the GNSS signals.

The processor 12 may determine the frame boundaries of the NTN signal's frame cycles based on the time reference 62 using an internal clock signal 60 of the electronic device 10. For example, the processor 12 may determine (e.g., track, calculate) durations of the NTN frame cycles and frame boundaries of each NTN frame cycle based on an internal time of the electronic device 10 determined by the internal clock signal 60. The electronic device 10 may include a local oscillator 64 that may generate the internal clock signal 60. Accordingly, the processor 12 and/or the GNSS receiver 56 may communicate with the NTN using the frame boundaries determined by receiving the GNSS signals.

The processor 12 may also determine the frame boundaries of the NTN signal's frame cycles based on receiving GNSS in-band interferences instead of or in addition to receiving the GNSS signals. For example, the GNSS receiver 56 (or the receiver 54) may receive the GNSS in-band interferences from a nearby device (e.g., a second electronic device 10) communicating with the NTN. The NTN signals and/or the GNSS in-band interferences may have a frequency in a second frequency band at least partially overlapping with or near a first frequency band of GNSS signals. The second frequency band may include an L-band frequency component (e.g., an L5 frequency band) with a frequency range of 600 kilohertz (KHz) to 17 megahertz (MHZ), 15 MHz to 17 MHz, and/or 1 to 2 gigahertz (GHz), among other possibilities. The first frequency band (e.g., an L1 frequency band) may have a frequency range similar to, substantially similar to, near a range of, or at least partially overlapping with that of the second frequency band. For example, the first frequency band may have an upper threshold equal to or less than 5 megahertz lower than a lower threshold of the second frequency band.

The first frequency band may be substantially saturated in an enveloped or covered area including the electronic device 10 during communication of the nearby device (e.g., the second electronic device 10) with the NTN. For example, the communication of the nearby device (e.g., the second electronic device 10) with the NTN may substantially saturate the digital domain of the first frequency band by causing GNSS in-band interference at the electronic device 10. With the foregoing in mind, the GNSS in-band interferences may be cyclically separated (e.g., divided) by a pattern of quiet periods based on the time reference 62. For example, the nearby device may generate and/or transmit the NTN signals causing the GNSS in-band interferences at the electronic device 10 by embedding the pattern of quiet periods with each NTN frame cycle. As such, the first frequency band may be unsaturated in the enveloped or covered area including the electronic device 10 during a time period of each of the quiet periods embedded with each NTN frame cycle, and may be saturated during a remainder of the NTN frame cycle associated with the NTN signals and/or the GNSS in-band interferences. In some embodiments, the processor 12 and/or the GNSS receiver 56 of the electronic device 10 may scan (e.g., monitor, listen) for the pattern of quiet periods being received between the GNSS in-band interferences. The processor 12 and/or the GNSS receiver 56 may process the GNSS in-band interferences to determine the pattern of the received quiet periods.

The pattern of the received quiet periods may be indicative of frame boundaries of NTN frame cycles for communicating with the NTN. As mentioned above, the memory 14 and/or the nonvolatile storage 16 of the electronic device 10 may store predetermined (e.g., standardized) patterns of quiet periods associated with each NTN frame cycle. The processor 12 may compare the pattern of the received quiet periods with the stored predetermined patterns. Moreover, the processor 12 may determine the time reference 62 using the internal clock signal 60 when the pattern of the received quiet periods corresponds to a stored predetermined pattern. For example, the processor 12 may determine the frame boundaries of the NTN frame cycles based on a predetermined time duration offset of the predetermined pattern. Moreover, the processor 12 may determine (e.g., calculate, track) the frame boundaries of the NTN frame cycles using the internal time of the internal clock signal 60. Accordingly, the processor 12 and/or the GNSS receiver 56 may communicate with the NTN using the frame boundaries determined by monitoring the GNSS in-band interferences.

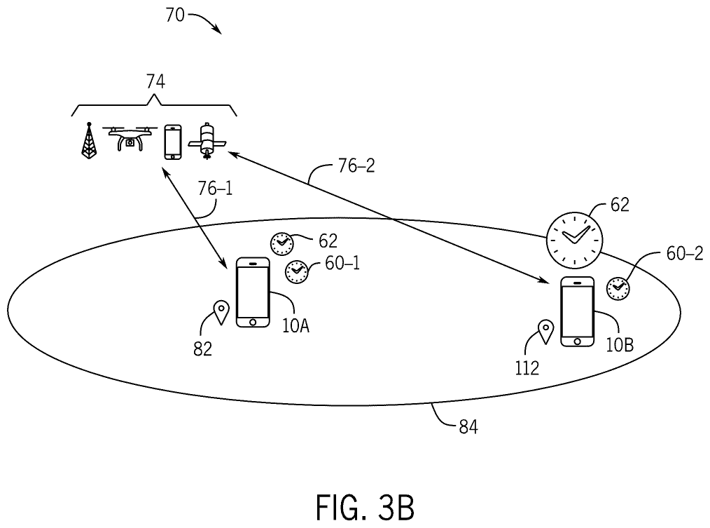

FIG. 3A is a schematic diagram of a communication system 70 that includes a GNSS 72, an NTN 74, and a first device 10A establishing communication and communicating with the NTN 74 based on receiving the time reference 62 from the GNSS 72, according to embodiments of the present disclosure. The communication system 70 may also include a second device 10B. It should be understood that the devices 10A and 10B may each include or be in the form of the electronic device 10. The NTN 74 may include a GNSS network, a non-GNSS non-terrestrial network, or any other suitable wireless communication network. Moreover, the NTN 74 is provided as an example, and in additional or alternative embodiments, the NTN 74 may instead be any other viable network including terrestrial networks such as radio access networks (RANs), WLANs, PANs, and so on.

The NTN 74 may include multiple communication nodes communicatively coupled together. By way of example, the communication nodes may include any suitable electronic device, such as non-terrestrial base stations, satellites, high-altitude platform stations, airborne base stations, space borne base stations, or any other suitable nonstationary or stationary communication devices, that may communicatively couple to the devices 10A and/or 10B. In additional or alternative embodiments, the communication node may include base stations, such as Next Generation NodeB (gNodeB or gNB) base stations and may provide 5G/NR coverage to the devices 10A and/or 10B, Evolved NodeB (eNodeB) base stations and may provide 4G/LTE coverage to the devices 10A and/or 10B, and so on.

The devices 10A and 10B may communicate with the NTN 74 by transmitting a signal via a respective transmitter 52 discussed above, which may be directed to at least one of the communication nodes of the NTN 74 (e.g., using an uplink process). The devices 10A and 10B may determine the time reference 62 associated with communicating with the NTN 74 to communicate with the NTN 74. The devices 10A and 10B may determine the frame boundaries of the NTN frame cycles based on the time reference 62 and the respective internal clock signals 60-1 and 60-2.

Each of the communication nodes may include transceivers (e.g., in the form of the transceiver 30) to receive signals from the devices 10A and 10B and/or any other suitable device transmitting signals to the communication nodes. In this way, the NTN 74 may receive the signal, process the signal, and/or relay or transmit an additional signal back to the devices 10A and/or 10B and/or to an additional device (e.g., using a downlink process). For example, the devices 10A and/or 10B may receive the signal from the NTN 74 via the respective receivers 54 discussed above. Upon receiving the signal, the devices 10A and/or 10B may process the signal to obtain information associated with the received signal.

With the foregoing in mind, the first device 10A may seek to establish (e.g., start) an NTN or other communication session with another device or infrastructure (e.g., via the NTN 74). To establish the communication session, the first device 10A may scan (e.g., monitor, listen to), receive, and decode GNSS signals 78 to determine the time reference 62. The GNSS 72 may transmit (e.g., broadcast) the GNSS signals 78 (and GNSS/GPS signals 86) including the time reference 62 indicative of the frame boundaries of the NTN frame cycles. In some cases, the first device 10A may additionally determine position and velocity estimates 82.

In this way, the first device 10A may determine a precise time, the frame boundaries of the NTN frame cycles for communicating with the NTN 74, and/or position from the GNSS signals 78. The first device 10A may initiate or start NTN/P2P/other communication using the precise time and/or the NTN frame cycles. The first device 10A may transmit NTN signals 76-1 directed to the NTN 74 in GNSS L1 and/or L5 bands by embedding a predetermined and cyclic pattern of quiet periods or transmission gaps with each NTN frame cycle determined based on the time reference 62.

The first device 10A may also leak transmission energy 84 having frequencies within or near the GNSS L1 and/or L5 bands while transmitting the NTN signals 76-1. As such, the transmission energy 84 may cause GNSS in-band interferences for receiver devices (e.g., the second device 10B) within an enveloped or covered area that is within a threshold distance (e.g., 5 meters (m) or less, 10 m or less, 15 m or less, 20 m or less, 20 m or more, and so on) of the first device 10A. For example, the enveloped or covered area may include one or more nearby devices such as the second device 10B.

The transmission energy 84, referred to hereinafter as the interferences 84 (e.g., interference time periods 84), may destructively interfere with and/or partially mask the GNSS/GPS signals 86 (or the GNSS signals 78). As such, the interferences 84 may cause GNSS in-band interferences at the second device 10B. Moreover, the second device 10B may not receive GNSS/GPS signals 86 (or the GNSS signals 78) or may receive the GNSS/GPS signals 86 (or the GNSS signals 78) with a gain (e.g., power, voltage, current) below a threshold. In such cases, the second device 10B may determine the time reference 62 and/or the NTN frame cycles by scanning for (e.g., monitoring for, listening to) the predetermined pattern of quiet periods embedded between two successive interferences 84 being received from the first device 10A (e.g., the time reference 62) in lieu of or in addition to receiving the time reference 62 from the GNSS 72. For example, each predetermined pattern of quiet periods may separate two successive interferences 84 within the enveloped or covered area. Moreover, each predetermined pattern of quiet periods may separate a first portion and a second (e.g., remaining) portion of a respective NTN frame cycle based on a first and/or a second predetermined time duration offsets.

FIG. 3B is a schematic diagram of the communication system 70 where the second device 10B establishes communication and communicates with the NTN 74 based on receiving the time reference 62 with the interferences 84, according to embodiments of the present disclosure. As mentioned above, the interferences 84 (e.g., the GNSS in-band interferences) may destructively interfere with and/or partially mask the GNSS/GPS signals 86 or the GNSS signals 78. In the depicted embodiment, the second device 10B (e.g., a victim device) may determine the time reference 62 for transmitting NTN signals 76-2 by scanning for (e.g., monitoring for, listening to) the predetermined pattern of quiet periods embedded between two successive the interferences 84 being received from the first device 10A. Moreover, the second device 10B may determine the frame boundaries of the NTN frame cycles based on the time reference 62. As such, the second device 10B may transmit the NTN signals 76-2 when the interferences 84 caused by the NTN signals 76-1 of the first device 10A (e.g., a nearby aggressor device) at least partially mask the GNSS signals.

In some embodiments, the second device 10B (and/or the first device 10A) may store one or more predetermined patterns of quiet periods associated with each NTN frame cycle. Each predetermined pattern may indicate one or more predetermined time duration offsets between the cyclic quiet periods and frame boundaries of the NTN frame cycles. For example, the second device 10B (and/or the first device 10A) may store a table storing (e.g., including, containing) the predetermined patterns and the respective time duration offsets.

The second device 10B may determine a pattern of received quiet periods based on the time reference 62. The second device 10B may determine whether the pattern of the received quiet periods corresponds to a stored predetermined pattern of quiet periods. If so, the second device 10B may determine the frame boundaries of the NTN frame cycles based on a predetermined time duration offset of the predetermined pattern and may communicate with the NTN 74 using the determined frame boundaries. In this way, the second device 10B may determine a precise time, the frame boundaries of the NTN frame cycles for communicating with the NTN 74, and/or position from the interferences 84. The second device 10B may initiate or start NTN/P2P/other communication using the precise time and/or the NTN frame cycles. In the depicted embodiment, the second device 10B may transmit NTN signals 76-2 directed to the NTN 74 in GNSS L1 and/or L5 bands. In some embodiments, the second device 10B may transmit the NTN signals 76-2 by embedding a predetermined and cyclic pattern of quiet periods or transmission gaps with each NTN frame cycle determined based on the time reference 62.

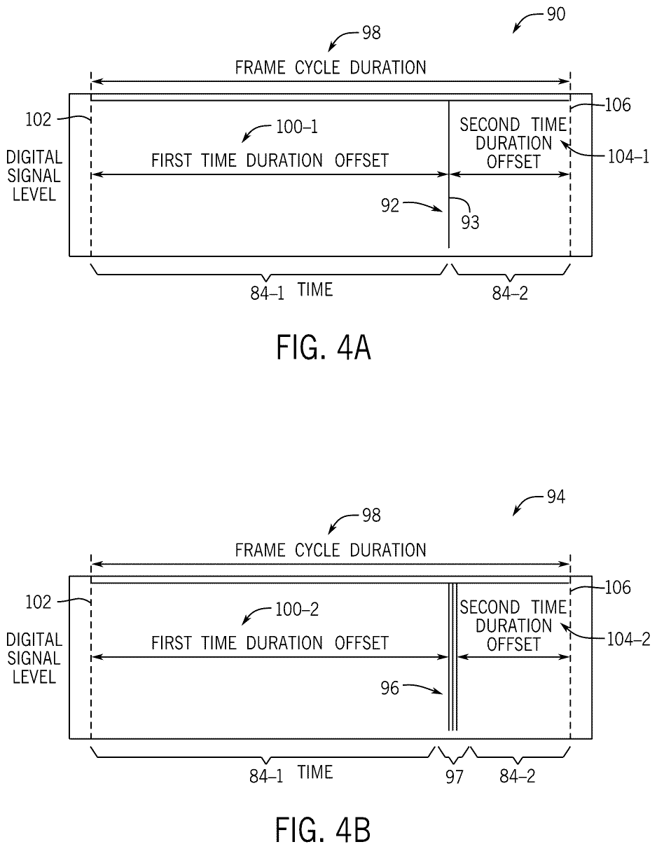

FIG. 4A is a timing diagram 90 illustrating a first pattern 92 of a quiet period 93 (e.g., quiet time period 93) embedded with a frame cycle of the NTN signals 76-1 and/or 76-2 (collectively the NTN signals 76), according to embodiments of the present disclosure. Moreover, FIG. 4B is a timing diagram 94 illustrating a second pattern 96 of multiple quiet periods 97 (e.g., quiet time periods 97) embedded with a frame cycle of the NTN signals 76, according to embodiments of the present disclosure. In some cases, the devices 10A and 10B (collectively electronic device 10) may transmit the NTN signals 76 by embedding the pattern 92 or 96 with each NTN frame cycle. Moreover, in some cases, the electronic device 10 may receive the interferences 84-1 and 84-2 (e.g., interference time periods 84-1 and 84-2) having the pattern 92 or 96 embedded therebetween. It should be appreciated that in alternative or additional embodiments, the electronic device 10 may transmit and/or receive signals (e.g., NTN signals 76, interferences 84-1 and 84-2) with a different pattern of quiet periods embedded with each frame cycle.

The timing diagrams 90 and 94 each illustrate a single NTN frame cycle having a frame cycle duration 98. In the depicted embodiments, the interferences 84-1 and 84-2 of the single NTN frame cycle are separated by the quiet periods. For example, the interferences 84-1 and 84-2 may be associated with received signals (e.g., GNSS in-band interferences) having a high digital signal voltage level equal to or above a high threshold. Moreover, the quiet periods may be associated with not receiving an interference 84 or receiving signals with a low digital signal voltage level equal to or below a low threshold.

The first pattern 92 may have a single quiet period 93 with a first predetermined time duration offset 100-1 (e.g., distance) from a beginning 102 of the frame cycle duration 98. The quiet period 93 of the first pattern 92 may have a second predetermined time duration offset 104-1 (e.g., distance) from an end 106 of the frame cycle duration 98. Moreover, the second pattern 96 may have multiple (e.g., 2, 3, 4, and so on) quiet periods 97 with a first predetermined time duration offset 100-2 from the beginning 102 of the frame cycle duration 98. The quiet periods 97 of the second pattern 96 may have a second predetermined time duration offset 104-2 from the end 106 of the frame cycle duration 98. In some cases, the second pattern 96 may have additional predetermined time duration offsets between two or more of the quiet periods 97. Each NTN frame cycle may have a first duration corresponding to the frame cycle duration 98 and each of the quiet periods 93 and/or 97 may have a second duration a fraction (e.g., smaller than, less than) of the first duration.

In some embodiments, the electronic device 10 may store the patterns 92 and/or 96 with one or more associated values corresponding to the predetermined time duration offsets 100 and/or 104 to determine the NTN frame cycles. In some cases, the electronic device 10 may transmit the NTN signals 76 discussed above by embedding the pattern 92 or 96 based on the stored values of the frame cycle duration 98 and/or the predetermined time duration offsets 100 and/or 104 (e.g., and/or the additional predetermined time duration offsets). In alternative or additional cases, the electronic device 10 may determine the patterns 92 and/or 96 based on receiving the GNSS signals 78 and/or 86 and/or receiving the interferences 84-1 and 84-2 discussed above.

For example, the electronic device 10 discussed above may determine the NTN frame cycles by determining the boundaries (e.g., the beginning 102 and the end 106) of each frame cycle based on the frame cycle duration 98 and/or the predetermined time duration offsets 100 and/or 104 (e.g., and/or the additional predetermined time duration offsets) associated with the patterns 92 and/or 96 of the received quiet periods. As such, the electronic device 10 may determine the NTN frame cycles by advantageously using the quiet periods 93 and/or 97 embedded between the two successive interferences 84-1 and 84-2 associated with an NTN frame cycle (e.g., GNSS in-band interferences). Accordingly, the electronic device 10 may communicate with the NTN even when GNSS in-band interferences from a nearby device masks the GNSS signals.

In some embodiments, the electronic device 10 may transmit the NTN signals 76 with one or more frequencies within the second frequency band near or partially overlapping the first frequency band. As such, in some cases, the NTN signals 76 may cause the interferences 84-1 and 84-2 at the first frequency band. The first frequency band may be substantially saturated (e.g., saturated digital signal domain) during the frame cycle duration 98 when receiving the interferences 84-1 and 84-2. For example, the first frequency band may be unsaturated during time periods of each of the quiet periods 93 and/or 97 embedded between the interferences 84-1 and 84-2 and may be saturated during a remainder of the frame cycle duration 98. The saturated frequency band may have the high digital signal voltage level equal to or above the high threshold and the unsaturated frequency band (e.g., unsaturated digital signal domain) may have the low digital signal voltage level equal to or below the low threshold.

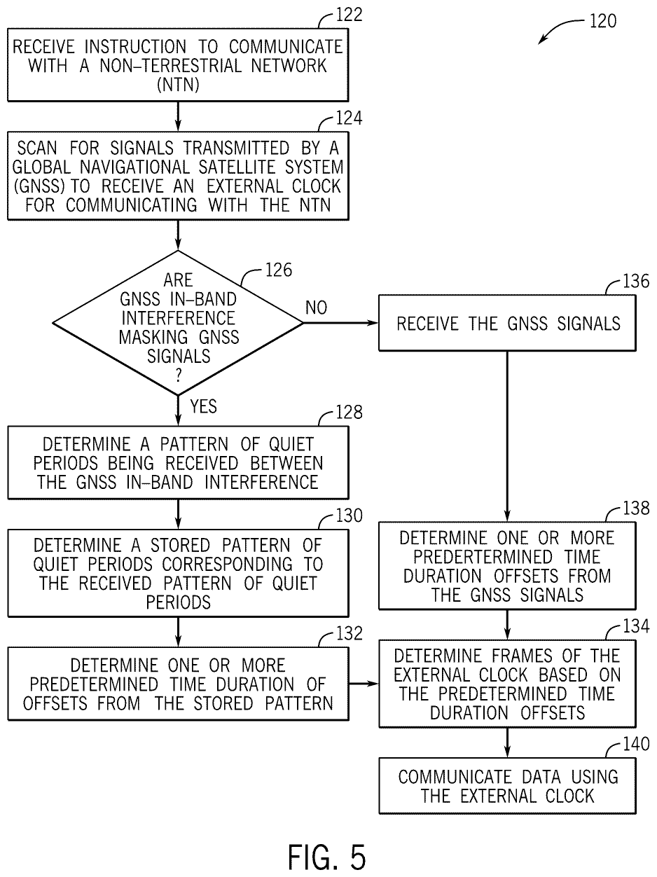

FIG. 5 is a process flow diagram illustrating an embodiment of a process 120 of establishing connection and communicating with the NTN 74 by the electronic device 10 based whether GNSS in-band interferences (e.g., the interferences 84) are present, in accordance with an aspect of the present disclosure. Although the following description of the process 120 is described with reference to the processor 12 of the electronic device 10, it should be noted that the process 120 may be partially or entirely performed by one or more other processors and/or controller of the electronic device 10 and/or the receiver 54 and/or the GNSS receiver 56 described above with respect to FIG. 2. Additionally, although the following process 120 describes a number of operations that may be performed, it should be noted that the process 120 may be performed in a variety of suitable orders and all of the operations may not be performed. The process 120 may be stored as instructions in tangible, computer-readable media such as the memory 14 and/or the nonvolatile storage 16.

A block 122, the processor 12 may receive instructions to communicate with the NTN 74. The processor 12 may perform operations of blocks 124-132 and 136 to determine the time reference 62 corresponding to an external clock for communicating with the NTN 74 based on the instructions. At block 124, the processor 12 may scan for GNSS signals 78 and/or 86 transmitted by the GNSS 72 to receive an indication of the external clock. For example, the processor 12 may generate instructions to cause the receiver 54 and/or the GNSS receiver 56 to receive the GNSS signals 78 and/or 86. The processor 12, the receiver 54, and/or the GNSS receiver 56 may scan (e.g., monitor, listen) for the GNSS signals 78 and/or 86 to receive the time reference 62.

At block 126, the processor 12 may determine whether the GNSS in-band interferences (e.g., the interferences 84) are masking (e.g., at least partially masking) the GNSS signals 78 and/or 86. If so, at block 128, the processor 12 may receive or determine a pattern of quiet periods being received between the GNSS in-band interferences. For example, the processor 12 may monitor for the quiet periods between interferences on a frequency channel (e.g., band) associated with the GNSS signals to receive and/or determine the pattern. The processor 12 may process the GNSS in-band interferences to determine the pattern of the received quiet periods. The pattern of the received quiet periods may correspond to the pattern 92 or 96 of FIGS. 4A and/or 4B, or any other viable predetermined (e.g., standardized) pattern of quiet periods.

Moreover, at block 130, the processor 12 may receive or determine a stored pattern of quiet periods corresponding to the pattern of the received quiet periods. For example, the electronic device 10 (e.g., the memory 14 and/or the nonvolatile storage 16) may store one or more predetermined patterns of quiet periods. Moreover, the processor 12 may determine, for example, whether a number of the quiet periods, a length of the quiet periods, and/or a distance between the quiet periods of a stored pattern corresponds to that of the pattern of the received quiet periods. The processor 12 may proceed to operations of block 132 in response to determining a stored pattern matching to the pattern of the received quiet periods.

At block 132, the processor 12 may determine one or more predetermined time duration offsets (e.g., the predetermined time duration offsets 100 and/or 104) from the stored pattern. The stored pattern and/or the one or more predetermined time duration offsets of the stored pattern may be indicative of the time reference 62. That is, the predetermined time duration offsets of the stored pattern may indicate a beginning (e.g., the beginning 102) and/or an end (e.g., the end 106) of an NTN frame cycle. As such, at block 134, the processor 12 may determine frames (e.g., frame cycles) of the external clock based on the predetermined time duration offsets. For example, the processor 12 may determine the frame boundaries of the NTN frame cycles based on the predetermined time duration offsets.

At block 126, the processor 12 may proceed to operations of blocks 136 and 138 when the GNSS in-band interferences (e.g., the interferences 84) are not masking the GNSS signals 78 and/or 86. At block 136, the processor 12 may receive the GNSS signals 78 and/or 86. The GNSS signals 78 and/or 86 may include an indication of the time reference 62. At block 138, the processor 12 may determine one or more predetermined time duration offsets (e.g., the predetermined time duration offsets 100 and/or 104) from the GNSS signals 78 and/or 86 (and/or the time reference 62). As such, processor 12 may proceed to operations of block 134 to determine frames (e.g., frame cycles) of the external clock based on the predetermined time duration offsets. For example, the processor may determine the frame boundaries of the NTN frame cycles based on the predetermined time duration offsets. Accordingly, the processor 12 may determine one or more predetermined time duration offsets (e.g., the predetermined time duration offsets 100 and/or 104) from the GNSS in-band interferences based on operations of blocks 128, 130, and 132, or from the GNSS signals 78 and/or 86 based on operations of blocks 136 and 138.

At block 140, the processor 12 may communicate data (e.g., the NTN signals 76) using the external clock. For example, the processor 12 may establish communication and communicate the NTN signals 76 with the NTN 74 using the frame boundaries of the NTN frame cycles. As such, the processor 12 may communicate with the NTN using the frame boundaries determined based on receiving the GNSS signals 78 and/or 86 as an indication of the time reference 62 or by monitoring the patterns of quiet periods indicative of the time reference 62 when the GNSS in-band interferences is masking the GNSS signals 78 and/or 86. That is, the processor 12 may communicate signals with the NTN 74 despite the GNSS signals 78 and/or 86 being masked or partially masked. Accordingly, operations of the electronic device 10 may be improved based on leveraging the GNSS in-band interferences of a transmitting device (e.g., a nearby device) to establish communication and communicate with the NTN 74.

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function]. . . ” or “step for [perform]ing [a function]. . . ,” it is intended that such elements are to be interpreted under 35 U.S.C. 112(f). However, for any claims containing elements designated in any other manner, it is intended that such elements are not to be interpreted under 35 U.S.C. 112(f).

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

1. An electronic device comprising:
a transceiver comprising a receiver and a transmitter; and
processing circuitry coupled to the transceiver, the processing circuitry configured to
instruct the receiver to receive a first signal from a first network, the first signal comprising an indication of an external clock associated with a second network,
receive interference during a plurality of interference time periods in lieu of or in addition to the first signal via the receiver, and
transmit a second signal to the second network by the transmitter based on a pattern of one or more received quiet time periods between the plurality of interference time periods, and a stored pattern of one or more quiet time periods corresponding to the pattern of the one or more received quiet time periods, the stored pattern being indicative of the external clock.

2. The electronic device of claim 1, wherein the receiver is configured to receive one or more first voltages equal to or below a first threshold during each received quiet time period of the one or more received quiet time periods and receive one or more second voltages equal to or above a second threshold higher than the first threshold during each interference time period of the plurality of interference time periods.

3. The electronic device of claim 2, wherein the processing circuitry is configured to determine the pattern of the one or more received quiet time periods based on a timing associated with receiving the one or more first voltages via the receiver.

4. The electronic device of claim 1, wherein the processing circuitry is configured to determine a plurality of frame cycles of the external clock based on the stored pattern.

5. The electronic device of claim 4, wherein the processing circuitry is configured to transmit the second signal based on the plurality of frame cycles.

6. The electronic device of claim 4, wherein each frame cycle of the plurality of frame cycles comprises a first duration, and each received quiet time period of the one or more received quiet time periods comprises a second duration less than the first duration.

7. The electronic device of claim 4, wherein the processing circuitry is configured to determine one or more time duration offsets between the pattern of the one or more received quiet time periods and a beginning boundary or an end boundary of each frame cycle of the plurality of frame cycles based on the stored pattern to determine the plurality of frame cycles.

8. The electronic device of claim 1, wherein the first network comprises a non-terrestrial network and the second network comprises a global navigational satellite system (GNSS) network, and the plurality of interference time periods comprises GNSS in-band interference.

9. A method comprising:
instructing, by processing circuitry, a receiver to receive a first signal of a first frequency band, the first signal comprising an indication of an external clock for communicating a second signal of a second frequency band,
receiving, by the processing circuitry, interference during a plurality of interference time periods at least partially masking the first signal via the receiver, and
transmitting, by the processing circuitry, the second signal by a transmitter based on one or more quiet time periods being received between the plurality of interference time periods, and the external clock being associated with the one or more quiet time periods.

10. The method of claim 9, wherein each quiet time period of the one or more quiet time periods is associated with one or more first voltages equal to or below a first threshold and each interference time period of the plurality of interference time periods is associated with one or more second voltages equal to or above a second threshold higher than the first threshold.

11. The method of claim 9, comprising determining, by the processing circuitry, one or more time duration offsets indicative of a beginning boundary or an end boundary of each frame cycle of a plurality of frame cycles based on the one or more quiet time periods.

12. The method of claim 9, comprising determining, by the processing circuitry, a plurality of frame cycles of the external clock for communicating with a non-terrestrial network (NTN) based on the one or more quiet time periods.

13. The method of claim 12, wherein each frame cycle of the plurality of frame cycles comprises a first duration and each quiet time period of the one or more quiet time periods comprises a second duration less than the first duration.

14. The method of claim 9, wherein the first signal is associated with a global navigational satellite system network and the second signal is associated with a non-terrestrial network.

15. Tangible, non-transitory, computer-readable media storing instructions that, when executed by processing circuitry, cause the processing circuitry to:
instruct a receiver to receive a first signal of a first frequency band, the first signal comprising an indication of an external clock to communicate a second signal of a second frequency band;
determine a pattern of quiet time periods being received based on receiving interference during a plurality of interference time periods via the receiver in lieu or in addition to the first signal;
determine the external clock based on the pattern of quiet time periods; and
transmit the second signal by a transmitter based on the external clock.

16. The tangible, non-transitory, computer-readable media of claim 15, wherein the first signal is associated with a global navigational satellite system network and the second signal is associated with a non-terrestrial network.

17. The tangible, non-transitory, computer-readable media of claim 15, wherein the plurality of interference time periods comprises global navigational satellite system in-band interference of a device.

18. The tangible, non-transitory, computer-readable media of claim 15, wherein the instructions cause the processing circuitry to determine a plurality of frame cycles of the external clock based on the pattern of quiet time periods.

19. The tangible, non-transitory, computer-readable media of claim 15, wherein the instructions cause the processing circuitry to determine one or more time duration offsets between the pattern of quiet time periods and a beginning boundary or an end boundary of each frame cycle of a plurality of frame cycles of the external clock.

20. The tangible, non-transitory, computer-readable media of claim 19, wherein the instructions cause the processing circuitry to transmit the second signal based on the beginning boundary or the end boundary of the plurality of frame cycles.
